(19) United States
(12) Patent Application Publication
(10) Pub. No.: US 2007/0081499 A1
(43) Pub. Date: Apr. 12, 2007

(54) Packet data protocol context utilization

(76) Inventor: Petter Johnsen, Arendal (NO)

Correspondence Address: POTOMAC PATENT GROUP, PLLC, P. O. BOX 270, FREDERICKSBURG, VA, 22404, US

(21) Appl. No.: 11/248,865

(22) Filed: Oct. 12, 2005

(51) Int. Cl. H04B 7/216

(52) U.S. Cl. 370/335

(57) ABSTRACT

A terminal equipment can use modem emulation and other services implemented by a mobile terminal in a packet-switched communication network while being unaware of primary and secondary packet data protocol (PDP) contexts used by the mobile terminal. The mobile terminal implements one or more packet filters that identify packets to be placed on uplink PDP contexts and that are generated by the mobile terminal based on conventional traffic flow templates.

### BACKGROUND

This invention relates to communication systems and more particularly to packet-switched communication systems.

In communication networks specified by the Third Generation Partnership Project (3GPP), access to packet-switched (PS) networks is provided through packet data protocol (PDP) contexts of different types. For example, a network supporting GSM's general packet radio service (GPRS) is one such 3GPP network, as are networks supporting Enhanced Data Rates for GSM Evolution (EDGE) and UTRAN, or the UMTS Terrestrial Radio Access Network. UTRAN is the part of the Universal Mobile Telecommunication System (UMTS) that includes radio network controllers (RNCs) and so-called Node Bs, which are analogous to base stations in other mobile telephone systems.

A PDP context is a PDP connection between user equipment (UE) and a gateway GPRS support node (GGSN), which is a router between the radio network and an external network, such as the internet. A commonly used PDP context type is the IP and IPv6 type. See, e.g., 3GPP Technical Specification (TS) 23.060 v 5.2.0, “General Packet Radio Service (GPRS); Service description; Stage 2 (Release 5)” (June 2002) and RFC 3314, Recommendations for IPv6 in Third Generation Partnership Project (3GPP) Standards, The Internet Society (September 2002), which is available at http://www.faqs.org/rfcs/rfc3314.html.

A PDP context has a number of characteristics that are defined at connection time. One of those characteristics is the quality of service (QoS), which is defined by a QoS profile. A UE sends the requested QoS profile to the network when the PDP context is activated. The network decides if the requested QoS is acceptable and indicates back to the UE the QoS that will be used on the connection.

3GPP has defined two procedures for PDP context activation in 3GPP TS 23.060, the latest version of which is v6.10.0 (September 2005), among other technical specifications. The PDP context activation procedure for PDP contexts of type IP and IPv6 activates a PDP context with a given QoS, and an IP address is assigned to the PDP context endpoint. PDP contexts activated by this PDP context activation procedure are called “primary PDP contexts” in this application.

The other procedure defined by 3GPP is the secondary PDP context activation procedure. A context activated by the secondary PDP context activation procedure is called a “secondary PDP context” in this application. When a secondary PDP context is activated, it is associated with one primary PDP context. The secondary PDP context inherits a number of parameters from the primary PDP context, such as access point name (APN), username, and password, and it takes the same IP address as the primary PDP context. A secondary PDP context usually differs from its associated primary PDP context in the QoS profile. The APN is a logical name that refers to a GGSN and an external network.

As the primary and associated secondary PDP contexts hold the same IP address, the two contexts are viewed as one connection from an IP level. Due to this, an IP packet will not hold sufficient information to decide if the packet shall be sent over the primary or secondary PDP context. This will be the case for both uplink and downlink traffic. In the uplink, this uncertainty is usually not a problem for applications executing in the UE, as out-of-band signaling can be used to guide the packet to the right PDP context.

For the downlink, 3GPP has defined traffic flow templates (TFTs) such that a TFT is associated with a PDP context, and in particular with a secondary PDP context. A TFT is defined by the UE, which may be a mobile terminal (MT), such as a mobile phone, and a terminal equipment (TE), such as a personal computer (PC), laptop computer, or other processor executing the application and connected to the MT. The TFT is sent to a GGSN in the PDP context activation procedure and the secondary PDP context activation procedure. The TFT describes which traffic shall be sent on the downlink for the respective PDP context, and thus a TFT can be considered a downlink packet filter or filters, with each filter containing a number of filter tags. The filter tags are parameters such as source IP address, protocol number, source and destination port numbers, and other IP level parameters. The filters contain at least one of those filter tags, and the filter tags can include wild cards.

When a downlink IP packet is received by the GGSN, the GGSN applies the filters in the TFT to the packet to determine if the packet matches the criteria described by the TFT. If the packet matches the TFT, the downlink packet is forwarded on the respective PDP context.

In a typical scenario, such as that illustrated in FIG. 1, the UE starts out by activating a primary PDP context with a given QoS, depicted by a pipe labeled Context1, QoS1, that connects the UE through a network cloud to a GGSN. Applications in the UE use the primary PDP context for communications, e.g., web browsing, through the GGSN to/from an internet service provider (ISP) located in another network cloud. As depicted in FIG. 1, the GGSN is connected to the ISP through an ISP Connection pipe. In addition, the primary PDP context Context1 has an associated traffic flow template TFT1, as described above.

At a later point in time, the UE determines that a different QoS is needed, for example because the user has selected a multimedia content streaming session that requires a different QoS. The UE then activates a secondary PDP context with the different QoS, depicted by a pipe labeled Context2, QoS2, that connects the UE through the network cloud to the GGSN, and the UE sends a respective second TFT TFT2 to the GGSN. The second TFT can contain the source IP address and source port number of a streaming server in the network cloud or other source at the end of the ISP connection, for example. Downlink packets associated with the streaming session are then placed on the secondary PDP context Context2 by the GGSN, while other traffic to/from the UE is directed to the primary PDP context Context1.

To enable a TE, such as a PC, to use an MT, such as a mobile phone, to connect the TE to the internet, it is now common for the MT to operate in a way such that the TE behaves as if it were using a traditional circuit-switched (CS) modem. Such modem emulation, which is illustrated by FIG. 2, entails control of the MT by the usual AT commands and in particular that a connection is set up by the AT Dial command. It will be understood that in general the AT prefix (also known as the Attention Code) signals the modem that one or more commands are to follow.

After issuing an AT Dial command, the TE expects to run the point-to-point protocol (PPP), which is the internet standard for transmitting network-layer datagrams (e.g., IP packets) over serial point-to-point communication links. In the conventional CS case, the TE runs the PPP toward a remote access server in the network, but when the MT emulates a CS connection for a PS connection, the PPP is terminated in the UE as specified by 3GPP. The TE thus does not know that it is connected to a PS bearer and a PDP context instead of a CS bearer, and the TE also does not know about the primary or secondary PDP contexts that are used by the MT for communication with the network, depicted by a cloud in FIG. 2.

The TE sees the link between the TE and MT as one link capable of carrying standard IP frames. Accordingly, nothing is done to direct uplink traffic from the TE to a secondary PDP context, although downlink traffic to the TE can still be controlled through TFTs as specified by 3GPP. In FIG. 2, the block in the MT labeled with a question-mark illustrates the problem of placing the uplink traffic at the correct uplink PDP context.

### SUMMARY

Among other things, this invention solves the problem of using a primary or secondary PDP context for uplink traffic from a TE connected to an MT through a link intended for IP traffic, such as a PPP serial link. The TE can continue to use the modem emulation implemented by the MT, and the TE can still be unaware of the MT's use of primary and secondary PDP contexts.

In one aspect of this invention, the MT implements one or more packet filters that identify packets to be placed on an uplink PDP context. The packet filters are generated by the MT based on the downlink packet filters (i.e., the TFTs) associated with the respective PDP context. In particular, there is provided an MT capable of enabling a TE to communicate with a packet-switched network. The MT includes a processor configured to configure at least one PDP context to be used by the TE for communication, the processor configuring the PDP context by setting at least one parameter of a TFT for the PDP context; and a processor configured to generate a MT TFT associated with the PDP context based on the TFT, where the MT TFT identifies packets to be placed on an uplink of the PDP context.

In another aspect of this invention, there is provided a method of handling information packets on an uplink in a communication device in a packet-switched network. The method includes the steps of configuring a PDP context, including a TFT; and generating a MT TFT based on the configured TFT. The MT TFT describes traffic on the uplink for the PDP context and enables traffic on the uplink to be directed to the PDP context.

In yet another aspect of this invention, there is provided a computer-readable medium containing a computer program for handling information packets on an uplink in a communication device in a packet-switched network. The computer program causes the communication device to perform the steps of configuring a PDP context, including a TFT; and generating a MT TFT based on the configured TFT. The MT TFT describes traffic on the uplink for the PDP context and enables traffic on the uplink to be directed to the PDP context.

### BRIEF DESCRIPTION OF THE DRAWINGS

The various features, advantages, and objects of this invention will be understood by reading this description in conjunction with the drawings, in which:

FIG. 1 illustrates primary and secondary PDP contexts;

FIG. 2 illustrates a problem in modem emulation with primary and secondary PDP contexts;

FIG. 3 is a block diagram of a communication system;

FIG. 4 is a block diagram of a mobile terminal;

FIG. 5 depicts protocol stacks in a terminal equipment and a terminal adapter;

FIG. 6 depicts a structure of a mobile terminal traffic flow template; and

FIG. 7 is a flow chart of a method of handling information packets on an uplink in a communication device such as a mobile terminal.

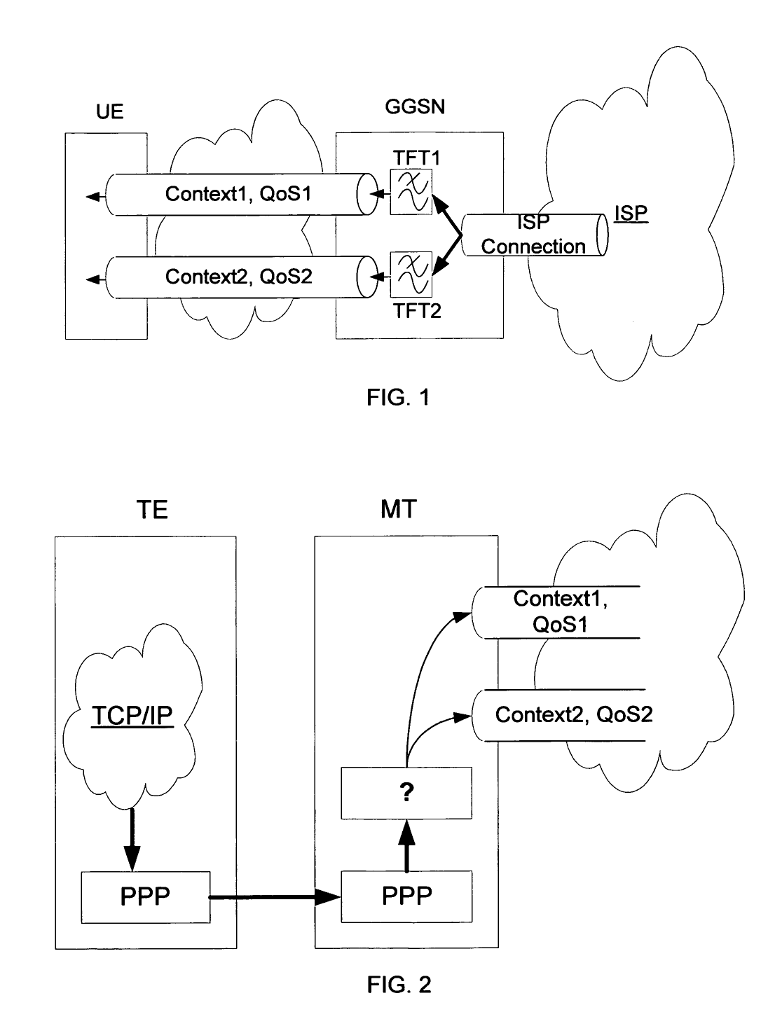

### DETAILED DESCRIPTION

As noted above, one of the aspects of this invention is that a TE can use the modem emulation or other services implemented by an MT while being unaware of primary and secondary PDP contexts used by the MT. It can be noted that several ways of activating a secondary PDP context are known. As described in more detail below, the MT can implement one or more packet filters that identify packets to be placed on an uplink primary or secondary PDP context, and these uplink packet filters (MT TFTs) can be generated by the MT based on the (downlink) TFTs for the respective context.

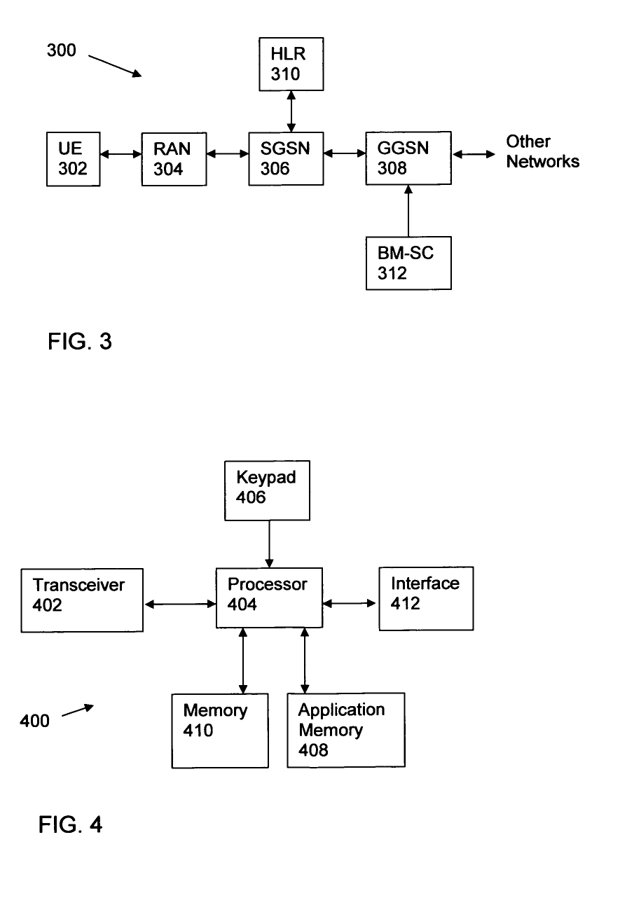

FIG. 3 is a block diagram of a communication system 300 that can employ the MT TFTs described in this application. A UE 302 communicates through a radio access network (RAN) 304, such as a GSM/EDGE network, with core-network entities, including a servicing GPRS support node (SGSN) 306, a GGSN 308, and a home location register (HLR) 310. The GGSN 308 communicates with other networks, such as the internet and public switched telephone networks, and other entities, such as a broadcast/multicast service center (BM-SC) 312. The RAN 304 includes one or more base stations (BSs) and base station controllers, or Node Bs and radio network controllers (RNCs), that are conventional. The RNCs control various radio network functions, including for example radio access bearer setup, diversity handover among BSs, etc. More generally, each RNC directs calls to and from a UE via the appropriate BSs, which communicate with each other through downlink (i.e., base-to-mobile or forward) and uplink (i.e., mobile-to-base or reverse) channels. Each BS serves a geographical area that is divided into one or more cell(s) and is typically coupled to its corresponding RNC by dedicated telephone lines, optical fiber links, microwave links, etc. The core-network entities are conventional and adapted to handle many types of data. In a typical GSM/EDGE network, PDP contexts for administering data flows are set up, or activated, in the GGSN 308 in response to requests from the UE 302 according to 3GPP TS 23.060, for example.

FIG. 4 is a block diagram of a MT 400, which may be included in the UE 302. The terminal 400 includes a suitable transceiver 402 for exchanging radio signals with BSs in the RAN 304. Information carried by those signals is handled by a processor 404, which may include one or more sub-processors, and which executes one or more software applications to carry out the operations of the terminal 400. User input to the terminal is provided through a keypad 406 or other device. The software applications may be stored in a suitable application memory 408, and the terminal may also download and/or cache desired information in a suitable memory 410. The MT 400 also includes an interface 412 that can be used to connect a TE to the MT.

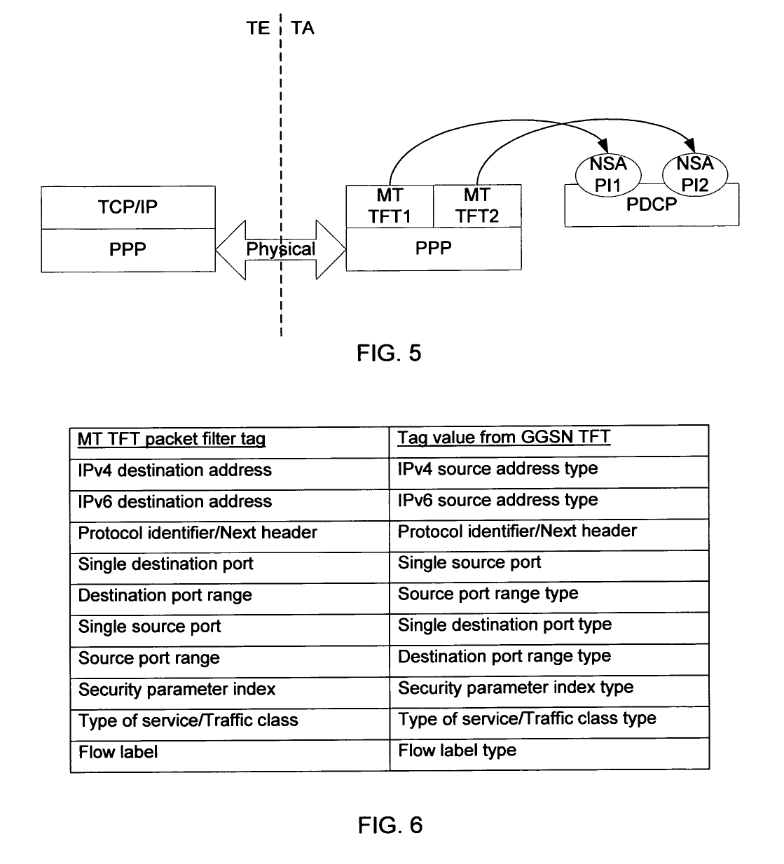

Referring to FIG. 5, a TE can be “physically” connected to an MT 400 through a serial link, such as RS-232, Infrared Data Association (IrDA), BLUETOOTH®, universal serial bus (USB), and other interfaces, that enables communication with the modem functionality in the MT. The MT, which may then have activated primary and possibly secondary PDP contexts from the MT towards the network, can be seen by the TE as, for example, a standard modem. This is depicted in FIG. 5 by a protocol stack that includes TCP/IP and PPP in the TE, and as described above, the connection between the protocol stacks in the TE and MT uses PPP. It will be understood that the TE can be external to the MT, e.g., the TE can be in the form of a PC, laptop computer, etc., or the TE can be internal to the MT, e.g., the TE can be in the form of an application-executing processor closely connected to the MT (e.g., integrated on the same printed circuit board or even in the same chip).

Before activating primary or secondary PDP contexts, the PDP contexts have to be configured. Configuring a PDP context involves setting the usual parameters needed for the context activation procedure, and this includes setting the QoS profile and the TFT for each PDP context. Configuration of the PDP contexts can be done by the MT in response to commands from the TE, e.g., AT commands specified by 3GPP or provided by the MT service provider, e.g., by over-the-air (OTA) or other means. It will be understood that the configuration of a PDP context must be done before context activation, and so the MT will store in its memory descriptions of the downlink traffic expected on each PDP context. In essence, such a stored description is the TFT for the respective PDP context. This information is stored in, for example, the memory 410.

In accordance with this invention, the MT uses the conventional PDP context configuration information to generate descriptions of the uplink traffic expected on the active PDP contexts. These descriptions are implemented by the MT in packet filter(s) in the uplink path(s), which then direct uplink traffic to the correct PDP context. Such an uplink packet filter in the MT is called an MT TFT in this application, and an MT TFT “mirrors” the TFT, or downlink packet filter, that is set in the GGSN.

FIG. 5 illustrates where the MT TFTs are placed with respect to the PPP and the packet data convergence protocol (PDCP) in the terminal adapter (TA) functionality of the MT's protocol stack. In FIG. 5, the primary PDP context is indicated by network service access point identifier (NSAPI) NSAPI1, which has associated MT TFT1, and a secondary PDP context is indicated by NSAPI2, which has associated MT TFT2.

The structure of the MT TFTs mirrors, or is substantially identical to, the structure of the conventional TFTs used by the GGSN. An MT TFT describes which traffic shall be sent on the uplink for the respective PDP context, and thus an MT TFT can be considered an uplink packet filter or filters, with each filter containing a number of filter tags. As in the conventional TFTs, it is advantageous for the filter tags in an MT TFT to include so-called “wild cards”. When an uplink IP packet is received by the MT, the MT applies the filters in the MT TFT to the packet, by operation of a processor in the MT, to determine if the packet matches the criteria described by the MT TFT. If the packet matches the MT TFT, the uplink packet is forwarded to the proper destination address.

An exemplary structure of an MT TFT is indicated by the table in FIG. 6, which shows tag names in the left-hand column. A processor or other suitable device in the MT can determine the values for the MT TFT tags by copying them from the conventional, or GGSN, TFT associated with the particular context. The right-hand column in FIG. 6 shows how the MT TFT tag values are filled in with values taken from the corresponding GGSN TFT. In particular, it can be seen that the IPv4 and IPv6 destination address tags in the MT TFT are set to the same value as the IPv4 and IPv6 source address in the GGSN TFT; the Protocol identifier/Next header tag in the MT TFT is set to the same value as the one set in the GGSN TFT; the Single destination port type tag in the MT TFT is set to the same value as the Single source port in the GGSN TFT; the Destination port range type tag in the MT TFT is set to the same value as the Source port range set in the GGSN TFT; and the Security parameter index, Type of service/Traffic class type, and Flow label type are set to the same values as in the corresponding GGSN TFT.

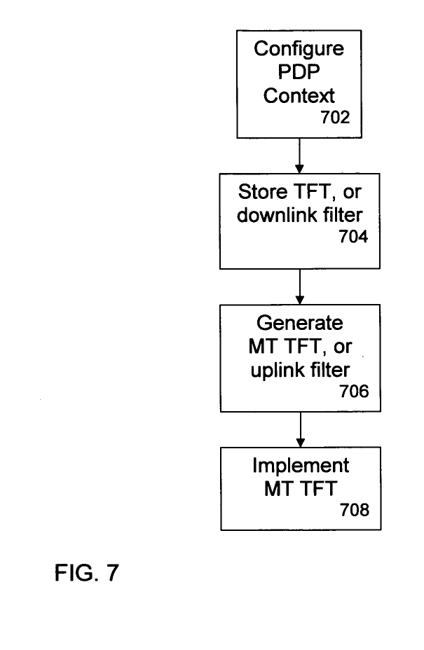

FIG. 7 is a flow chart of a method of handling information packets on a packet-switched uplink in a communication device such as a mobile terminal as described above. In step 702, a PDP context is configured. This step includes setting the parameters needed for the context activation procedure, which are at least some of the parameters listed in the right-hand column of the table in FIG. 6, including the QoS profile and the TFT for the PDP context. In step 704, the MT stores the TFT for the PDP context, for example in its local memory. In step 706, the TFT is used to generate an MT TFT that describes which traffic shall be sent on the uplink for the respective PDP context. In step 708, this description is implemented by the MT in the uplink path, with the result that uplink traffic is directed to the correct PDP context. When an uplink IP packet is received, a suitable processor applies the MT TFT to the packet, determining if the packet matches the criteria described by the MT TFT. If the packet matches the MT TFT, the uplink packet is forwarded to the proper destination address.

It will be appreciated that MT TFTs as described above enable an operating system running on a TE or application processor connected to an MT to be agnostic to, or not to care about, the fact that cellular GSM and UMTS packet-switched modems utilize secondary and primary PDP contexts to handle different parts of the traffic with different QoS. Typical operating systems running on PCs do not support running traffic over a secondary PDP context, and are therefore limited in possible QoS utilizations. Operating systems running on other processors, such as application-specific integrated circuits, gate arrays, etc., are also limited in their support of secondary PDP contexts. With MT TFTs described here, however, full QoS and PDP context utilizations are possible with no change in the operating systems.

It will further be appreciated that the MT TFTs described above can be generally used for mapping uplink traffic to a corresponding context in an uplink coming in to the MT over any IP bearer. Thus, PPP is only one possible link layer. Just a few examples of several other possible link layers are Ethernet and IEEE 802.11 wireless local area network (WLAN) link layers.

Moreover, this invention can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random-access memory (RAM), a read-only memory (ROM), an erasable programmable read-only memory (EPROM or Flash memory), and an optical fiber.

It is expected that this invention can be implemented in a wide variety of environments, including for example mobile communication devices. It will also be appreciated that procedures described above are carried out repetitively as necessary. To facilitate understanding, aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

It is emphasized that the terms “comprises” and “comprising”, when used in this application, specify the presence of stated features, integers, steps, or components and do not preclude the presence or addition of one or more other features, integers, steps, components, or groups thereof.

Thus, this invention may be embodied in many different forms, not all of which are described above, and all such forms are contemplated to be within the scope of the invention. The particular embodiments described above are merely illustrative and should not be considered restrictive in any way. The scope of the invention is determined by the following claims, and all variations and equivalents that fall within the range of the claims are intended to be embraced therein.

What is claimed is:

1. A mobile terminal capable of enabling a terminal equipment to communicate with a packet-switched network, comprising:
a processor configured to configure at least one packet data protocol (PDP) context to be used by the terminal equipment for communication, wherein the processor configures the PDP context by setting at least one parameter of a traffic flow template (TFT) for the PDP context; and
a processor configured to generate a mobile terminal TFT (MT TFT) associated with the PDP context based on the TFT for the PDP context;
wherein the MT TFT identifies packets to be placed on an uplink of the PDP context.

2. The mobile terminal of claim 1, wherein the MT TFT mirrors the TFT.

3. The mobile terminal of claim 2, wherein the processor determines values for the tags in the MT TFT by copying the values from the TFT for the PDP context.

4. The mobile terminal of claim 3, wherein the processor sets an internet protocol (IP) destination address tag in the MT TFT to a value of an IP source address in the TFT.

5. The mobile terminal of claim 1, wherein the mobile terminal emulates a circuit-switched modem to the terminal equipment.

6. A method of handling information packets on an uplink in a communication device in a packet-switched network, comprising the steps of:
configuring a packet data protocol (PDP) context, including a traffic flow template (TFT); and
generating a mobile terminal TFT (MT TFT) based on the configured TFT, wherein the MT TFT describes traffic on the uplink for the PDP context and enables traffic on the uplink to be directed to the PDP context.

7. The method of claim 6, further comprising the step of implementing the MT TFT in the uplink of the PDP context, wherein uplink traffic is directed to the PDP context.

8. The method of claim 6, wherein the configuring step includes setting parameters needed for a PDP context activation procedure.

9. The method of claim 8, wherein the parameters include a quality-of-service profile and a traffic flow template for the PDP context.

10. The method of claim 6, further comprising the step of storing the TFT for the PDP context.

11. The method of claim 6, wherein the implementing step includes determining whether a received information packet matches criteria described by the MT TFT, and if the received information packet matches the criteria, forwarding the received information packet to a destination address.

12. A computer-readable medium containing a computer program for handling information packets on an uplink in a communication device in a packet-switched network, the computer program causing the communication device to perform the steps of:
configuring a packet data protocol (PDP) context, including a traffic flow template (TFT); and
generating a mobile terminal TFT (MT TFT) based on the configured TFT, wherein the MT TFT describes traffic on the uplink for the PDP context and enables traffic on the uplink to be directed to the PDP context.

13. The computer-readable medium of claim 12, wherein the computer program causes the communication device to perform the further step of implementing the MT TFT in the uplink of the PDP context, wherein uplink traffic is directed to the PDP context.

14. The computer-readable medium of claim 12, wherein the configuring step includes setting parameters needed for a PDP context activation procedure.

15. The computer-readable medium of claim 14, wherein the parameters include a quality-of-service profile and a traffic flow template for the PDP context.

16. The computer-readable medium of claim 12, wherein the computer program causes the communication device to perform the further step of storing the TFT for the PDP context.

17. The computer-readable medium of claim 12, wherein the implementing step includes determining whether a received information packet matches criteria described by the MT TFT, and if the received information packet matches the criteria, forwarding the received information packet to a destination address.
